(19) United States
(12) Patent Application Publication
(10) Pub. No.: US 2013/0083294 A1
(43) Pub. Date: Apr. 4, 2013

(54) ILLUMINATION SYSTEM AND PROJECTION APPARATUS

(71) Applicant: Chih-Neng Tseng, Hsin-Chu (TW)

(72) Inventor: Chih-Neng Tseng, Hsin-Chu (TW)

(73) Assignee: CORETRONIC CORPORATION, Hsin-Chu (TW)

(21) Appl. No.: 13/587,933

(22) Filed: Aug. 17, 2012

(30) Foreign Application Priority Data
Sep. 30, 2011 (CN) 201110305242.8

(51) Int. Cl. G03B 21/14; F21V 9/16

(52) U.S. Cl. 353/31; 362/84

(57) ABSTRACT

An illumination system is provided, including a blue incoherent light source, a coherent light source, a phosphor module and a beam combining unit. The blue incoherent light source is capable of emitting a blue incoherent light beam. The coherent light source is capable of emitting a coherent light beam. The phosphor module has a first color phosphor zone and a second color phosphor zone. The first color phosphor zone and the second color phosphor zone move into a transmission path of the coherent light beam in turn, to convert the coherent light beam to a first color light beam and a second color light beam respectively. The beam combining unit is disposed on transmission paths of the blue incoherent light beam, the first color light beam and the second color light beam. A projection apparatus is also provided.

### CROSS-REFERENCE TO RELATED APPLICATION

This application claims the priority benefit of China application serial no. 201110305242.8, filed on Sep. 30, 2011. The entirety of the above-mentioned patent application is hereby incorporated by reference herein and made a part of specification.

### BACKGROUND OF THE INVENTION

1. Field of the Invention

The invention relates to a light source and a display device, in particular, to an illumination system and a projection apparatus.

2. Description of Related Art

A projection apparatus usually adopts an ultra high pressure lamp (UHP lamp) as a light source. However, in recent years, it is also a trend to adopt a light-emitting diode (LED) as the light source. Although the LED has the advantages such as a high reaction speed, no requirement for idling time, energy saving, eco-friendly, and a long service life, a luminance of the LED is lower than the UHP lamp, and therefore in the prior art, it is difficult to apply the LED to a high-luminance projection apparatus.

A pure laser source is adopted in a prior art to excite a phosphor, to generate multiple colors. In such a prior art, a blue laser light that penetrates an optical element is adopted as blue light. As the blue laser light has a high coherency, if the blue laser is directly used in the projection apparatus, a speckle phenomenon occurs, which leads to an uneven image; therefore, a diffuser film should be adopted to reduce a speckle degree. However, a reliability problem concerning the diffuser film experiencing long-term irradiation by the blue laser may occur, which further shortens the service life of the projection apparatus. In addition, in the prior art, the blue laser light penetrating the optical element is designed in coordination with other optical elements to form a complete optical path, so that the entire optical path occupies a large size, making it difficult to reduce an overall size of the projection apparatus. In addition, adopting other optical elements is likely to increase the cost. Moreover, the color of blue laser light is close to blue-violet instead of perfect blue, which easily affects a color quality of an image of the projection apparatus.

The US patent publication No. 20110063581 has disclosed a light source of a projector, in which exciting light emitted by a laser source excites a blue phosphor material and a green phosphor material on a phosphor wheel, to respectively generate blue light and green light. In addition, the US patent publication No. 20110051102 has also disclosed a light source of a projector.

### SUMMARY OF THE INVENTION

Accordingly, the invention is directed to an illumination system, which has advantages such as a high luminance, desirable color balance, a small size and a low cost.

The invention is directed to a projection apparatus, which has advantages such as a high luminance, desirable color balance, a small size and a low cost.

Other advantages of the invention can be further understood from technological features disclosed in the invention.

In order to achieve one of or a part of or all of the above advantages or other advantages, an embodiment of the invention provides an illumination system, which includes a blue incoherent light source, a coherent light source, a phosphor module and a beam combining unit. The blue incoherent light source is capable of emitting a blue incoherent light beam. The coherent light source is capable of emitting a coherent light beam. The phosphor module has a first color phosphor zone and a second color phosphor zone, in which the first color phosphor zone and the second color phosphor zone move into a transmission path of the coherent light beam in turn, to convert the coherent light beam to a first color light beam and a second color light beam respectively. The beam combining unit is disposed on transmission paths of the blue incoherent light beam, the first color light beam and the second color light beam, to combine the blue incoherent light beam, the first color light beam and the second color light beam.

Another embodiment of the invention provides a projection apparatus, which includes the above illumination system, a light valve and a projection lens. The beam combining unit is capable of combining the blue incoherent light beam, the first light beam and the second light beam into an illumination light beam. The light valve is disposed on a transmission path of the illumination light beam, to convert the illumination light beam to an image light beam. The projection lens is disposed on a transmission path of the image light beam.

In the illumination system and the projection apparatus according to the embodiments of the invention, as the blue incoherent light source is adopted to generate the blue incoherent light beam, and the coherent light beam generated by the coherent light source is adopted to excite the phosphor module, the illumination system and the projection apparatus have a high luminance and desirable color balance at the same time. In addition, the illumination system and the projection apparatus in the embodiments of the invention adopt the beam combining unit to combine the blue incoherent light beam, the first color light beam and the second color light beam. Therefore, the size of the illumination system and the projection apparatus may be reduced, and the cost of the illumination system and the projection apparatus is decreased as less optical elements are used.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic view of a projection apparatus according to an embodiment of the invention.

FIG. 2 is a front view of a phosphor module in FIG. 1.

FIG. 3 is a schematic view of a projection apparatus according to another embodiment of the invention.

FIG. 4 to FIG. 6 are time sequence diagrams of the illumination system of FIG. 1 respectively in a bright mode, a high chroma mode, and a standard mode.

### DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

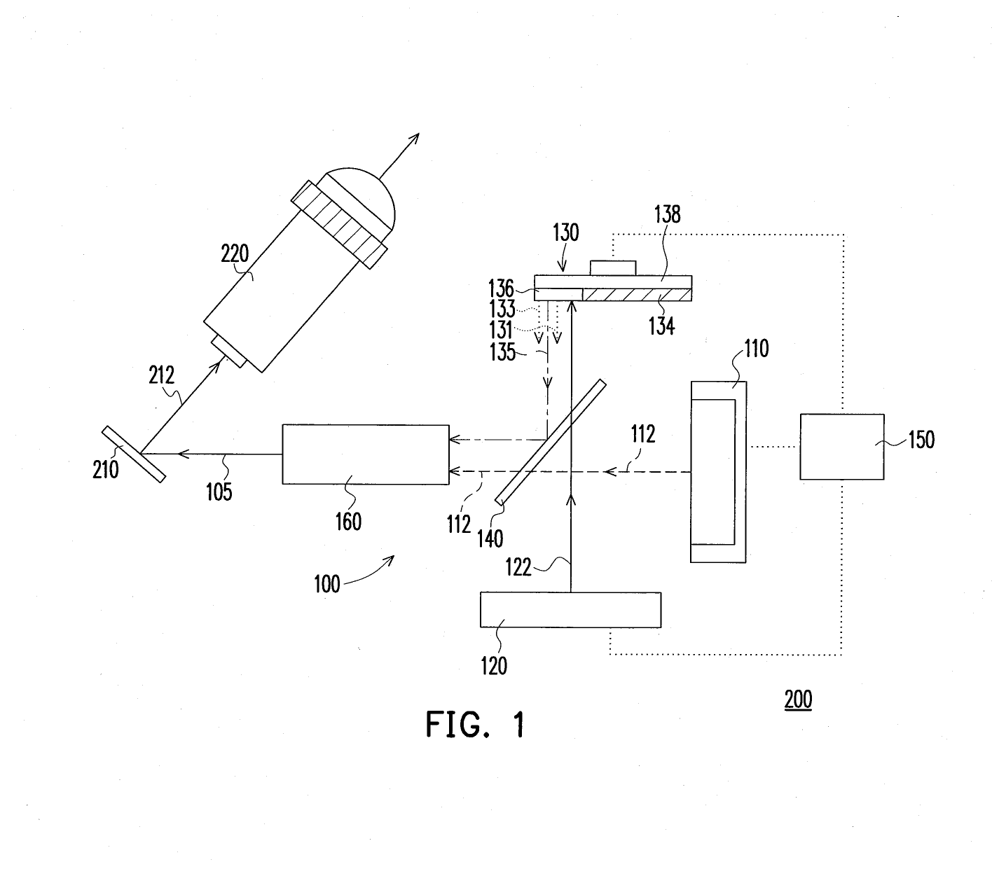

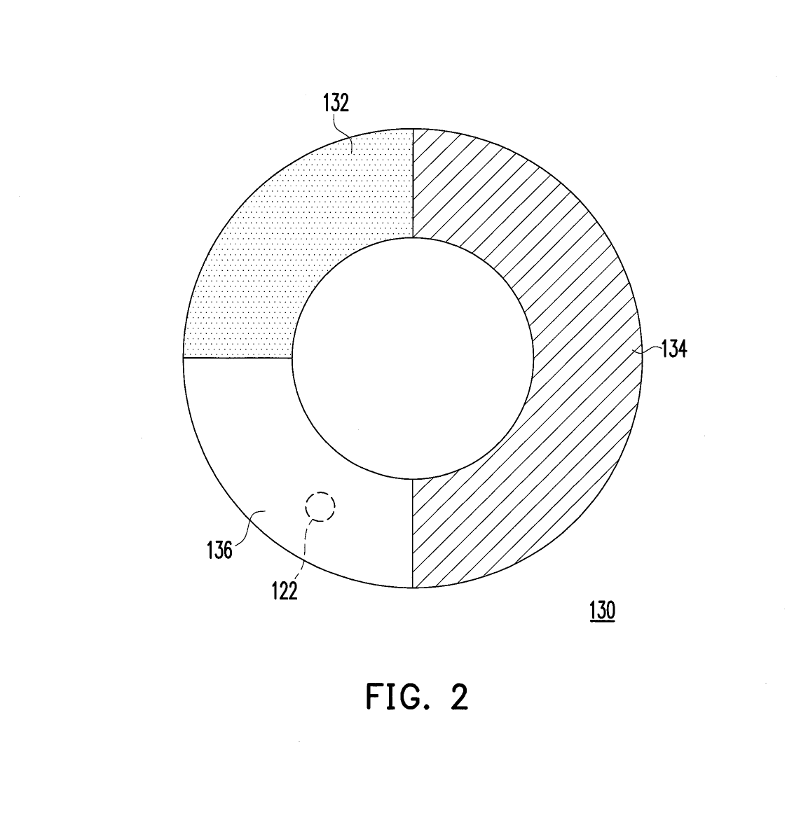

FIG. 1 is a schematic view of a projection apparatus according to an embodiment of the invention, and FIG. 2 is a front view of a phosphor module in FIG. 1. Referring to FIG. 1 and FIG. 2, a projection apparatus 200 of this embodiment includes an illumination system 100, a light valve 210 and a projection lens 220. The illumination system 100 includes a blue incoherent light source 110, a coherent light source 120, a phosphor module 130 and a beam combining unit 140. The blue incoherent light source 110 is capable of emitting a blue incoherent light beam 112. In this embodiment, the blue incoherent light source 110 is, for example, an LED of blue light. The coherent light source 120 is capable of emitting a coherent light beam 122, in which a wavelength of the coherent light beam 122 is less than or equal to that of the blue incoherent light beam 112. In other words, the coherent light beam 122 is, for example, an ultraviolet light beam, a blue-violet light beam or a blue light beam. In this embodiment, the coherent light source 120 is a laser source, and the coherent light beam 122 is a laser beam.

The phosphor module 130 has a first color phosphor zone 132 (as shown in FIG. 2) and a second color phosphor zone 134, in which the first color phosphor zone 132 and the second color phosphor zone 134 move into a transmission path of the coherent light beam 122 in turn, to convert the coherent light beam 122 to a first color light beam 131 and a second color light beam 133 respectively. In this embodiment, the phosphor module 130 is, for example, a phosphor wheel, which is capable of rotating so that the first color phosphor zone 132 and the second color phosphor zone 134 move into the transmission path of the coherent light beam 122 in sequence. When the first color phosphor zone 132 is located on the transmission path of the coherent light beam 122, the coherent light beam 122 excites the first color phosphor zone 132 to generate the first color light beam 131. When the second color phosphor zone 134 is located on the transmission path of the coherent light beam 122, the coherent light beam 122 excites the second color phosphor zone 134 to generate the second color light beam 133.

In this embodiment, the phosphor module 130 further includes a third color phosphor zone 136, in which the first color phosphor zone 132, the second color phosphor zone 134 and the third color phosphor zone 136 move into the transmission path of the coherent light beam 122 in turn, to convert the coherent light beam 122 to the first color light beam 131, the second color light beam 133 and a third color light beam 135, respectively. In FIG. 1 and FIG. 2, it is taken as an example that the third color phosphor zone 136 moves into the transmission path of the coherent light beam 122, and at this time, the coherent light beam 122 excites the third color phosphor zone 136 to generate the third color light beam 135.

In addition, in this embodiment, the first color phosphor zone 132, the second color phosphor zone 134 and the third color phosphor zone 136 are respectively a red phosphor zone, a green phosphor zone and a yellow phosphor zone, and the first color light beam 131, the second color light beam 133 and the third color light beam 135 are respectively a red light beam, a green light beam and a yellow light beam. However, the invention does not limit the color of each zone, and the color of each zone is decided according to requirements of a designer.

The beam combining unit 140 is disposed on transmission paths of the blue incoherent light beam 112, the first color light beam 131 and the second color light beam 133, to combine the blue incoherent light beam 112, the first color light beam 131 and the second color light beam 133 into an illumination light beam 105. In this embodiment, the beam combining unit 140 is also disposed on a transmission path of the third color light beam 135, to combine the blue incoherent light beam 112, the first color light beam 131, the second color light beam 133 and the third color light beam 135 into the illumination light beam 105.

In this embodiment, the phosphor module 130 further includes a reflection substrate 138, and the first color phosphor zone 132, the second color phosphor zone 134 and the third color phosphor zone 136 are disposed on the reflection substrate 138. For example, the first color phosphor zone 132, the second color phosphor zone 134 and the third color phosphor zone 136 are a first color phosphor, a second color phosphor and a third color phosphor coated on the reflection substrate 138. The coherent light beam 122 excites the first color phosphor zone 132, the second color phosphor zone 134 and the third color phosphor zone 136 to respectively generate the first color light beam 131, the second color light beam 133 and the third color light beam 135, and the reflection substrate 138 reflects the first color light beam 131, the second color light beam 133 and the third color light beam 135 to the beam combining unit 140.

In this embodiment, the illumination system 100 further includes an optical homogenization element 160 disposed on a transmission path of the illumination light beam 105. In this embodiment, the optical homogenization element 160 is disposed on the transmission path of the blue incoherent light beam 112, the first color light beam 131, the second color light beam 133 and the third color light beam 135, to homogenize the illumination light beam 105. The optical homogenization element 160 may be, for example, an integration rod; however, in other embodiments, the optical homogenization element 160 may also be a lens array.

The light valve 210 is disposed on the transmission path of the illumination light beam 105, to convert the illumination light beam 105 into an image light beam 212. In this embodiment, the light valve 210 may be, for example, a digital micro-mirror device (DMD). However, in other embodiments, the light valve 210 may be a liquid-crystal-on-silicon panel (LCOS panel) or any other appropriate spatial light modulator. The projection lens 220 is disposed on a transmission path of the image light beam 212, to project the image light beam 212 to a screen to generate an image.

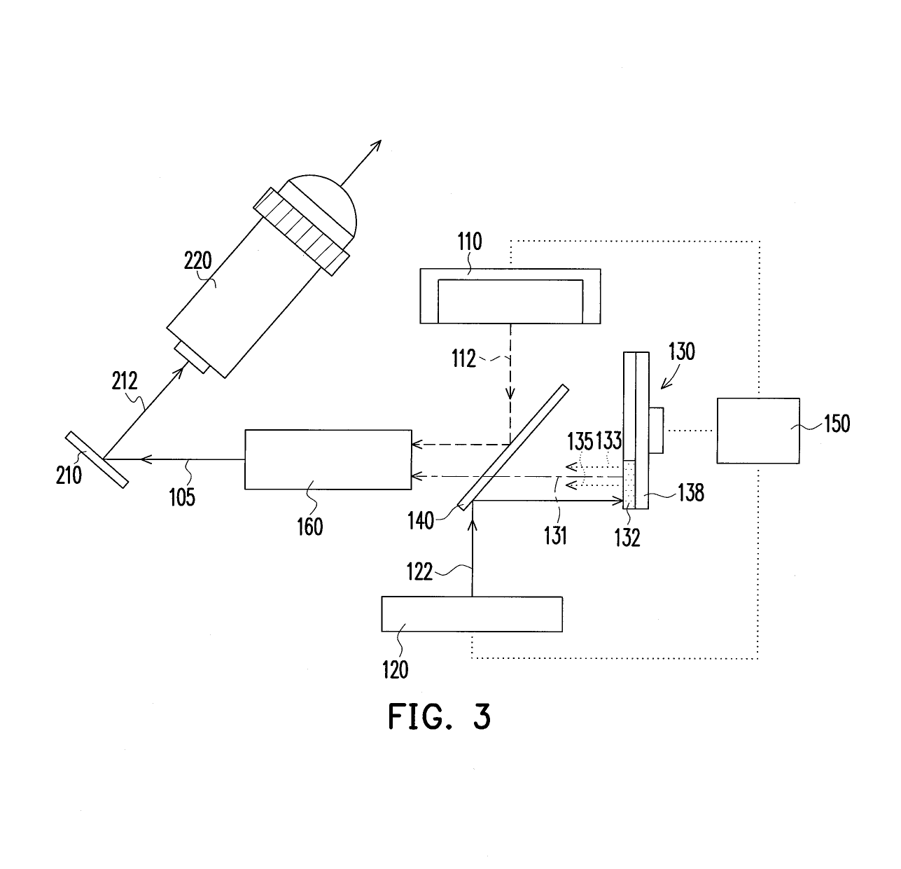

In this embodiment, the beam combining unit 140 is a dichroic unit, for example, a dichroic mirror. However, in other embodiments, the beam combining unit 140 may be a dichroic prism. In this embodiment, the beam combining unit 140 is further disposed on the transmission path of the coherent light beam 122, and the beam combining unit 140 is capable of transmitting the coherent light beam 122 from the coherent light source 120 to the phosphor module 130. Specifically, in this embodiment, the beam combining unit 140 is capable of allowing the coherent light beam 122 to penetrate and transmit the coherent light beam 122 to the phosphor module 130. The beam combining module 140 is capable of allowing the blue incoherent light beam 112 to penetrate and transmit the blue incoherent light beam 112 to the optical homogenization element 160 and the light valve 210, and the beam combining unit 140 is capable of reflecting the first color light beam 131, the second color light beam 133 and the third color light beam 135 to the optical homogenization element 160 and the light valve 210. In other words, the beam combining unit 140 is capable of allowing the blue light beam and a light beam with a wavelength shorter than that of the blue light beam to penetrate, and is capable of reflecting the red light beam, green light beam and yellow light beam. However, in another embodiment as shown in FIG. 3, the beam combining unit 140 may reflect the coherent light beam 122 to the phosphor module 130; the beam combining unit 140 may reflect the blue incoherent light beam 112 to the optical homogenization element 160 and the light valve 210, and the beam combining unit 140 may be capable of allowing the first color light beam 131, the second color light beam 133 and the third color light beam 135 to penetrate and transmit the first color light beam 131, the second color light beam 133 and the third color light beam 135 to the optical homogenization element 160 and the light valve 210. In other words, in another embodiment, the beam combining unit 140 is capable of reflecting the blue light beam and a light beam with a wavelength shorter than that of the blue light beam, and is capable of allowing the red light beam, green light beam and yellow light beam to penetrate. Moreover, in the embodiment of FIG. 3, the blue incoherent light source 110 and the coherent light source 120 are respectively disposed on opposite sides of the beam combining unit 140.

In the illumination system 100 and the projection apparatus 200 of this embodiment, as the blue incoherent light source 110 is adopted to generate the blue incoherent light beam 112, the blue incoherent light beam with the color close to the perfect blue could be obtained to solve the problem in the prior art that the color of the laser beam is close to blue-violet. In this manner, the illumination system 100 and the projection apparatus 200 of this embodiment could achieve desirable color balance. In addition, as the coherent light beam 122 emitted by the coherent light source 120 is adopted to excite the phosphor module 130, to generate the first color light beam 131, the second color light beam 133 and the third color light beam 135 that have high intensity, the illumination system 100 and the projection apparatus 200 of this embodiment could achieve high luminance. In this embodiment, the luminance of the illumination system 100 and the projection apparatus 200 may be improved by increasing the number of laser generators in the coherent light source 120. In addition, the illumination system 100 and the projection apparatus 200 in this embodiment adopt a reflection-type phosphor module 130 (namely, the reflection substrate 138 is adopted in the phosphor module 130) to reflect the first color light beam 131, the second color light beam 133 and the third color light beam 135 to the beam combining unit 140, and the beam combining unit 140 is adopted to combine the blue incoherent light beam 112, the first color light beam 131, the second color light beam 133 and the third color light beam 135. Therefore, a structure of the optical path is simple. In this manner, the size of the illumination system 100 and the projection apparatus 200 may be reduced, and the cost of the illumination system 100 and the projection apparatus 200 is decreased as less optical elements are used.

Furthermore, as the adopted blue incoherent light beam 112 is an incoherent light beam, and the coherent light beam 122 is used to excite the phosphor module 130 and is not directly transmitted to the light valve 210, the illumination system 100 and the projection apparatus 200 of this embodiment do not have the speckle problem caused by the laser. As a result, speckle reducing elements such as a diffuser film are not required. In this manner, the reliability problem caused by the diffuser film experiencing long-term irradiation of the laser in the prior art does not occur.

In the embodiments of FIGS. 1 and 3, there may be at least one optics (e.g. at least one lens, not shown) disposed between the coherent light source 120 and the beam combining module 140. There may be at least one optics (e.g. at least one lens, not shown) disposed between the phosphor module 130 and the beam combining module 140. There may be at least one optics (e.g. at least one lens, not shown) disposed between the optical homogenization element 160 and the beam combining module 140. There may be at least one optics (e.g. at least one lens, not shown) disposed between the blue incoherent light source 110 and the beam combining module 140. There may be at least one optics (e.g. at least one lens, not shown) disposed between the optical homogenization element 160 and the light valve 210. Above-mentioned optics, for example, is at least one lens or a plurality of optical elements defined that the optics may facilitate light transmission and light focusing functions, which a person of ordinary skill in the art knows.

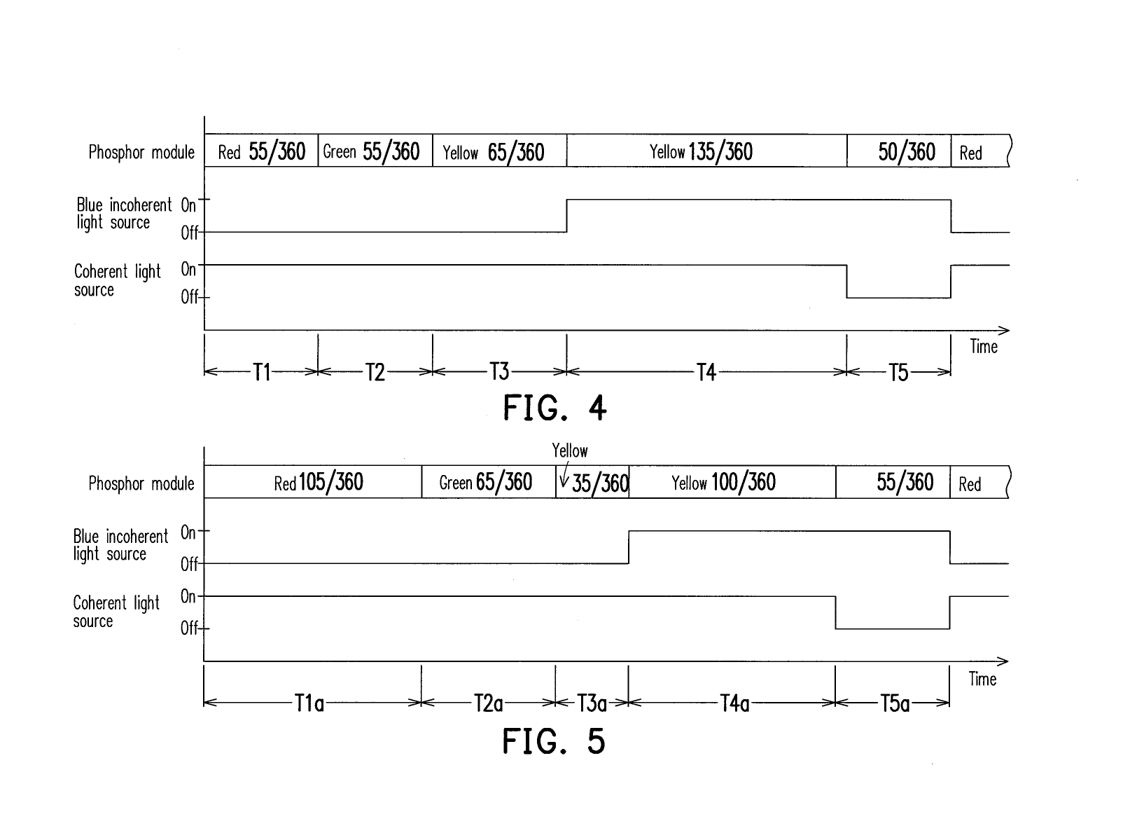

FIG. 4 to FIG. 6 are time sequence diagrams of the illumination system of FIG. 1 respectively in a bright mode, a high chroma mode, and a standard mode. Referring to FIG. 1 and FIG. 4 to FIG. 6, the illumination system 100 of this embodiment further includes a control unit 150 electrically connected to the blue incoherent light source 110, the coherent light source 120 and the phosphor module 130, to control light emitting time of the blue incoherent light source 110 and the coherent light source 120. Referring to FIG. 1 and FIG. 4, when the illumination system 100 is in the bright mode, the control unit 150 makes a time interval T5 less than a time interval T2, and makes the time interval T5 less than a time interval T3, in which the time interval T5 is time when the blue incoherent light source 110 emits light but the coherent light source 120 does not emit light, the time interval T2 is time when the coherent light beam 122 irradiates the green phosphor zone 134 and the blue incoherent light source 110 does not emit light, and the time interval T3 is time when the coherent light beam 122 irradiates the yellow phosphor zone 136 and the blue incoherent light source 110 does not emit light. As human eyes are sensitive to colors of green and yellow, increasing intensity of green light and yellow light makes human eyes feel higher luminance. For example, during a frame, when an time length of either of the blue incoherent light source 110 and the coherent light source 120 being turned on is defined as 360/360 (namely 1), a length of a time interval T1 is, for example, 55/360, a length of the time interval T2 is, for example, 55/360, a length of the time interval T3 is, for example, 65/360, a length of a time interval T4 is, for example, 135/360, and a length of the time interval T5 is, for example, 50/360, in which the time interval T1 is time when the coherent light beam 122 irradiates the red phosphor zone 132 and the blue incoherent light source 110 does not emit light, and the time interval T4 is time when the coherent light beam 122 irradiates the yellow phosphor zone 136 and the blue incoherent light source 110 emits light at the same time. In the time interval T4, the blue incoherent light beam 112 is mixed, by the beam combining unit 140, with the third color light beam 135 (namely the yellow light beam) into a white light beam. A time ratio from the above time interval T1 to the time interval T5 is merely an example, and is not intended to limit the invention. In addition, a sequence from the time interval T1 to the time interval T5 may be exchanged randomly in other embodiments, and the invention does not limit a time occurrence sequence.

In this embodiment, the above time length 360/360 may be time for the phosphor module 130 to rotate for 360° from a preset position, and the time interval T1, the time interval T2, the time interval T3, the time interval T4 and the time interval T5 may be time for the phosphor module 130 to rotate for 55°, 55°, 65°, 135° and 50° respectively from the preset position. In addition, the color of the phosphor zone of the phosphor module 130 corresponding to the time interval T5 may be any color, including red, green, yellow or any other color, which is because the coherent light source 120 does not emit light at this time and does not excite the phosphor module 130, and therefore, the phosphor zone may be any color at this time. In this embodiment, it is taken as an example that the time interval T1, the time interval T2, the time interval T3, the time interval T4 and the time interval T5 are continuous. However, in other embodiments, in order to further allocate the ratio of light with different colors, at least one of the time interval T1, the time interval T2, the time interval T3, the time interval T4 and the time interval T5 may be shortened, so that time when neither the coherent light source 120 nor the blue incoherent light source 110 emits light exists between any two adjacent time intervals while the phosphor module 130 still keeps rotating at this time.

Further referring to FIG. 1 and FIG. 5, when the illumination system 100 is in the high chroma mode, the control unit 150 makes a time interval T3a less than a time interval T1a and makes the time interval T3a less than a time interval T2a; the control unit 150 controls the time interval T3a less than a time interval T5a, in which the time interval T3a is time when the coherent light beam 122 irradiates the yellow phosphor zone 136 and the blue incoherent light source 110 does not emit light, the time interval T1a is time when the coherent light beam 122 irradiates the red phosphor zone 132 and the blue incoherent light source 110 does not emit light, the time interval T2a is time when the coherent light beam 122 irradiates the green phosphor zone 134 and the blue incoherent light source 110 does not emit light, and a time interval T4a is time when the coherent light beam 122 irradiates the yellow phosphor zone 136 and the blue incoherent light source 110 emits light at the same time, and the time interval T5a is time when the blue incoherent light source 110 emits light and the coherent light source 120 does not emit light. By increasing the intensity of the red light, the blue light and the green light, and reducing the intensity of the yellow light and the white light, the chroma and color saturation of the image may be improved. The high chroma mode may be used in an occasion where the requirement on color saturation is high, for example, when a movie or a photograph is played. In this embodiment, lengths of the time intervals T1a to T5a respectively occupy 105/360, 65/360, 35/360, 100/360 and 55/360, but the invention is not limited thereto.

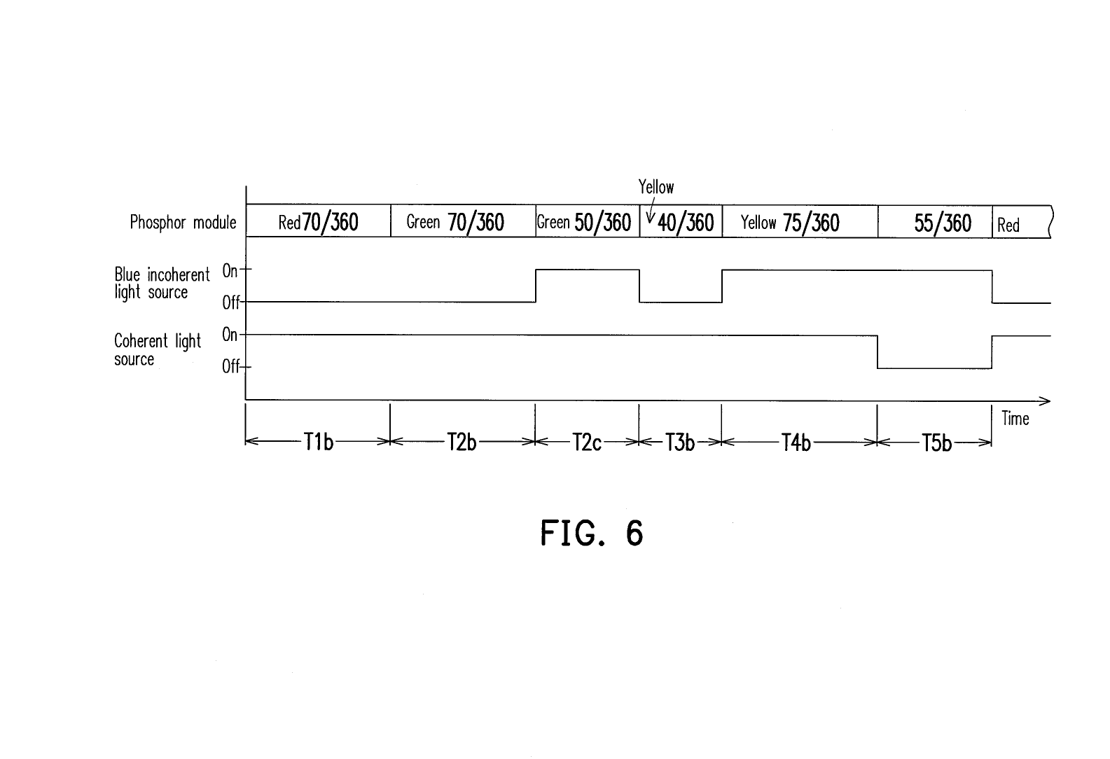

Further, referring to FIG. 6, when the illumination system 100 is in the standard mode, lengths of time intervals T1b, T2b, T2c, T3b, T4b and T5b are allocated more averagely, in which a time interval T2c is time when the coherent light beam 122 irradiates the green phosphor zone 134 and the blue incoherent light source 110 emits light at the same time. In the time interval T2c, the beam combining unit 140 mixes the green light beam 133 from the green phosphor zone 134 and the blue incoherent light beam 112 into a blue-green light beam. In this embodiment, lengths of the time intervals T1b, T2b, T2c, T3b, T4b and T5b respectively occupy 70/360, 70/360, 50/360, 40/360, 75/360 and 55/360, but the invention is not limited thereto.

The bright mode, the high chroma mode and the standard mode of this embodiment may be set when illumination system leaves the factory, and the illumination system 100 may operate according to one of the modes fixedly. Alternatively, the bright mode, the high chroma mode and the standard mode of this embodiment may be selected by a user interface electrically connected to the control unit 150, so that a user adjusts the illumination system to a required mode according to requirements. For example, when the user needs to use high-luminance projection, the user may switch the illumination system 100 to the bright mode through the user interface. When the user expects to play a movie or a photograph, the user may switch the illumination system 100 to the high chroma mode through the user interface. In addition, in a general use case, the user may switch the illumination system 100 to the standard mode through the user interface. Furthermore, the designer or user may even adjust light emitting time and a light emitting duration of the coherent light source 120 and the blue incoherent light source 110 to achieve a programmed dynamic design or change a color mixture ratio of light beams of different colors, so as to meet use requirements.

In conclusion, in the illumination system and the projection apparatus according to the embodiments of the invention, as the blue incoherent light source is adopted to generate the blue incoherent light beam, and coherent light beam generated by the coherent light source is adopted to excite the phosphor module, the illumination system and the projection apparatus could have a high luminance and desirable color balance at the same time. In addition, the illumination system and the projection apparatus in the embodiments of the invention adopt the beam combining unit to combine the blue incoherent light beam, the first color light beam and the second color light beam. Therefore, the size of the illumination system and the projection apparatus may be reduced, and the cost of the illumination system and the projection apparatus is decreased as less optical elements are used.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the invention as defined by the following claims. Moreover, no element and component in the present disclosure is intended to be dedicated to the public regardless of whether the element or component is explicitly recited in the following claims. Moreover, the first color phosphor zone, the second color phosphor zone and the third color phosphor zone mentioned in the specification are merely used for representing the names of the elements only, but are not intended to restrict the upper limit or lower limit of the number of the elements.

What is claimed is:

1. An illumination system, comprising:
a blue incoherent light source, capable of emitting a blue incoherent light beam;
a coherent light source, capable of emitting a coherent light beam;
a phosphor module, comprising a first color phosphor zone and a second color phosphor zone, wherein the first color phosphor zone and the second color phosphor zone move into a transmission path of the coherent light beam in turn, to convert the coherent light beam into a first color light beam and a second color light beam respectively; and
a beam combining unit, disposed on transmission paths of the blue incoherent light beam, the first color light beam and the second color light beam, to combine the blue incoherent light beam, the first color light beam and the second color light beam.

2. The illumination system according to claim 1, wherein the beam combining unit is a dichroic unit and is disposed on the transmission path of the coherent light beam, and the dichroic unit is capable of causing the coherent light beam from the coherent light source to transmit to the phosphor module.

3. The illumination system according to claim 1, wherein the phosphor module further comprises a third color phosphor zone; the first color phosphor zone, the second color phosphor zone and the third color phosphor zone move into the transmission path of the coherent light beam in turn, to convert the coherent light beam into the first color light beam, the second color light beam and the third color light beam respectively.

4. The illumination system according to claim 3, wherein the first color phosphor zone, the second color phosphor zone and the third color phosphor zone are respectively a red phosphor zone, a green phosphor zone and a yellow phosphor zone, and the first color light beam, the second color light beam and the third color light beam are respectively a red light beam, a green light beam and a yellow light beam.

5. The illumination system according to claim 4, further comprising a control unit, electrically connected to the blue incoherent light source, the coherent light source and the phosphor module, to control light emitting time of the blue incoherent light source and the coherent light source.

6. The illumination system according to claim 5, wherein when the illumination system is in a bright mode, the control unit makes a first time interval less than a second time interval, and makes the first time interval less than a third time interval; the first time interval is time when the blue incoherent light source emits light but the coherent light source does not emit light, the second time interval is time when the coherent light beam irradiates the green phosphor zone and the blue incoherent light source does not emit light, and the third time interval is time when the coherent light beam irradiates the yellow phosphor zone and the blue incoherent light source does not emit light.

7. The illumination system according to claim 5, wherein when the illumination system is in a high chroma mode, the control unit makes a first time interval less than a second time interval, makes the first time interval less than a third time interval, and makes the first time interval less than a fourth time interval; the first time interval is time when the coherent light beam irradiates the yellow phosphor zone and the blue incoherent light source does not emit light, the second time interval is time when the coherent light beam irradiates the red phosphor zone and the blue incoherent light source does not emit light, the third time interval is time when the coherent light beam irradiates the green phosphor zone and the blue incoherent light source does not emit light, and the fourth time interval is time when the blue incoherent light source emits light and the coherent light source does not emit light.

8. The illumination system according to claim 1, wherein the blue incoherent light source is a light-emitting diode (LED) of blue light.

9. The illumination system according to claim 1, wherein the phosphor module is a wheel comprising phosphor material.

10. The illumination system according to claim 1, further comprising a control unit, electrically connected to the blue incoherent light source, the coherent light source and the phosphor module, to control light emitting time of the blue incoherent light source and the coherent light source.

11. The illumination system according to claim 1, wherein a wavelength of the coherent light beam is less than or equal to that of the blue incoherent light beam.

12. A projection apparatus, comprising:
an illumination system, comprising:
a blue incoherent light source, capable of emitting a blue incoherent light beam;
a coherent light source, capable of emitting a coherent light beam;
a phosphor module, comprising a first color phosphor zone and a second color phosphor zone, wherein the first color phosphor zone and the second color phosphor zone move into a transmission path of the coherent light beam in turn, to convert the coherent light beam to a first color light beam and a second color light beam respectively; and
a beam combining unit, disposed on transmission paths of the blue incoherent light beam, the first color light beam and the second color light beam, to combine the blue incoherent light beam, the first color light beam and the second color light beam into an illumination light beam;
a light valve, disposed on a transmission path of the illumination light beam, to convert the illumination light beam to an image light beam; and
a projection lens, disposed on a transmission path of the image light beam.

13. The projection apparatus according to claim 12, wherein the beam combining unit is a dichroic unit and is disposed on the transmission path of the coherent light beam, and the dichroic unit is capable of transmitting the coherent light beam from the coherent light source to the phosphor module.

14. The projection apparatus according to claim 12, wherein the phosphor module further comprises a third color phosphor zone; the first color phosphor zone, the second color phosphor zone and the third color phosphor zone move into the transmission path of the coherent light beam in turn, to convert the coherent light beam to the first color light beam, the second color light beam and the third color light beam respectively.

15. The projection apparatus according to claim 14, wherein the first color phosphor zone, the second color phosphor zone and the third color phosphor zone are respectively a red phosphor zone, a green phosphor zone and a yellow phosphor zone, and the first color light beam, the second color light beam and the third color light beam are respectively a red light beam, a green light beam and a yellow light beam.

16. The projection apparatus according to claim 15, wherein the illumination system further comprises a control unit, electrically connected to the blue incoherent light source, the coherent light source and the phosphor module, to control light emitting time of the blue incoherent light source and the coherent light source.

17. The projection apparatus according to claim 16, wherein when the illumination system is in a bright mode, the control unit makes a first time interval less than a second time interval, and makes the first time interval less than a third time interval; the first time interval is time when the blue incoherent light source emits light but the coherent light source does not emit light, the second time interval is time when the coherent light beam irradiates the green phosphor zone and the blue incoherent light source does not emit light, and the third time interval is time when the coherent light beam irradiates the yellow phosphor zone and the blue incoherent light source does not emit light.

18. The projection apparatus according to claim 16, wherein when the illumination system is in a high chroma mode, the control unit makes a first time interval less than a second time interval, makes the first time interval less than a third time interval, and makes the first time interval less than a fourth time interval; the first time interval is time when the coherent light beam irradiates the yellow phosphor zone and the blue incoherent light source does not emit light, the second time interval is time when the coherent light beam irradiates the red phosphor zone and the blue incoherent light source does not emit light, the third time interval is time when the coherent light beam irradiates the green phosphor zone and the blue incoherent light source does not emit light, and the fourth time interval is time when the blue incoherent light source emits light and the coherent light source does not emit light.

19. The projection apparatus according to claim 12, wherein the blue incoherent light source is a light-emitting diode (LED) of blue light.

20. The projection apparatus according to claim 12, wherein the phosphor module is a wheel comprising phosphor material.

21. The projection apparatus according to claim 12, wherein the illumination system further comprises a control unit, electrically connected to the blue incoherent light source, the coherent light source and the phosphor module, to control light emitting time of the blue incoherent light source and the coherent light source.

22. The projection apparatus according to claim 12, wherein a wavelength of the coherent light beam is less than or equal to that of the blue incoherent light beam.

23. An illumination system, comprising:
a blue incoherent light source, capable of emitting a blue incoherent light beam;
a coherent light source, capable of emitting a coherent light beam;
a phosphor module, comprising a first color phosphor zone and a second color phosphor zone, wherein the first color phosphor zone and the second color phosphor zone move into a transmission path of the coherent light beam in turn, to convert the coherent light beam into a first color light beam and a second color light beam respectively; and
a beam combining unit, disposed on transmission paths of the blue incoherent light beam, the first color light beam and the second color light beam, to combine the blue incoherent light beam, the first color light beam and the second color light beam, wherein the blue incoherent light source and the coherent light source are respectively disposed on opposite sides of the beam combining unit.

24. The illumination system according to claim 23, further comprising an optical homogenization element disposed on the transmission paths of the blue incoherent light beam, the first color light beam and the second color light beam from the beam combining unit.

25. The illumination system according to claim 24, wherein when the coherent light beam emitted from the coherent light source is reflected by the beam combining unit, the first color light beam and the second color light beam converted by the phosphor module are transmitted sequentially to the optical homogenization element through the beam combining unit and the blue incoherent light beam reflected by the beam combining element is transmitted to the optical homogenization element.

26. The illumination system according to claim 23, wherein a wavelength of the coherent light beam is less than or equal to that of the blue incoherent light beam.
